(19) United States
(12) Patent Application Publication
(10) Pub. No.: US 2008/0219427 A1
(43) Pub. Date: Sep. 11, 2008

(54) INFORMATION TERMINAL, SERVER AND COMMUNICATION METHOD AND METHOD FOR SELECTING A COMMUNICATION SERVICE

(76) Inventors: Norihiko NAONO, Tokyo (JP); Tomohisa Ohta, Tokyo (JP)

Correspondence Address: WINSTON & STRAWN LLP;PATENT DEPARTMENT, 1700 K STREET, N.W., WASHINGTON, DC, 20006, US

(21) Appl. No.: 12/044,794

(22) Filed: Mar. 7, 2008

(30) Foreign Application Priority Data
Mar. 9, 2007 (JP) P2007-59957
May 2, 2007 (JP) P2007-121676

(51) Int. Cl. H04M 3/42

(52) U.S. Cl. 379/218.01

(57) ABSTRACT

An information terminal includes a microprocessor for gathering a plurality of information sets of a user, with the user being a communication partner, and the information set including an identification tag for specifying the communication partner, communication service information corresponding to a specific communication service among a plurality of communication services and contact information of the communication partner, and a storage device for storing the plurality of information sets.

### REFERENCE TO RELATED APPLICATIONS

This application is based upon and claims the benefit of priority from the prior Japanese Patent Application No. 2007-59957, filed on Mar. 9, 2007 and Japanese Patent Application No. 2007-121676, filed on May 2, 2007 the entire contents of which are incorporated herein by reference.

### TECHNICAL FIELD

The present invention relates to communication terminals, contact information, contact lists, address books, address lists, phone books, a display method, an information processing method and database to establish communications after obtaining information required for connecting partners between communication terminals.

### DESCRIPTION OF THE RELATED ART

Many communication terminals have either a storage device to store information required for connecting with a communication partner or a means for communicating with servers that store information required for connecting communication partners. A user of communication terminals can start communicating with a communication partner within a communication service as needed by using information that uniquely specifies a partner, (hereinafter referred to as “contact information”) either from a terminal's storage device or from a server. For example, in most cases, a mobile phone user can start a call not only by entering a phone number, which is contact information, by pressing the number buttons, but also by calling the already registered name of a communication partner from the storage device of the mobile phone terminal and using the phone number correlated with that name. Moreover, it is also applicable to communication such as e-mail, chatting, IP phoning, etc. which are widely used in generic information terminals such as PCs and mobile phones etc. The name of the communication partner is stored in the storage device of an information terminal in advance or obtained via a network from a service provider's server and by using the name of this communication partner, communication can start by using information such as an address or username which is information that has been correlated with the communication partner's name. This has the advantage in that communication can start even though users themselves do not directly enter the communication partner's contact information into the communication terminal.

In recent years, a large number of communication means have opened up with the development of various networking technologies. For example, the Internet Protocol (IP) communication function is installed in most mobile phones. Consequently, by using the IP communication function, communication by Short Message Service (SMS) or e-mail. Is possible over mobile phones and recently, a number of mobile phones enable communication by IP telephone in addition to conventional voice communication. In short, a mobile phone user can communicate with any partner with a single mobile device while selecting from multiple methods of communication such as e-mail, SMS, voice communication provided by the mobile phone, and voice communication by IP phone.

This trend is even more significant in communication with the use of generic information terminals such as PCs. A PC user communicates with any partner while selecting various methods of communication such as e-mailing, voice communication or teleconferencing by IP phone, text chatting, any file transfer by File Transfer Protocol (FTP) or Hyper-text Transfer Protocol (HTTP) through the Internet, as necessary. In more recent years, so-to-speak web mail type e-mail has rapidly been popularized. It is intended to store e-mail data in a server storage device through a website having a means to authenticate a user and then to access this data through the Internet from the web browser of an information terminal such as a PC. Many users of information terminals utilize multiple web mail type e-mail services. They communicate with any partner while selecting multiple e-mail services which differ for each web mail service, as necessary, in addition to the e-mail services that depend on such conventional protocols such as Simple Mail Transfer Protocol (SMTP) or Post Office Protocol (POP).

Moreover, in the service called Social Networking Service (hereinafter referred to as “SNS”) (see U.S. Pat. No. 7,069,308 which is incorporated as a reference) that has rapidly become rapidly in recent years, terminal users with information to disclose, store various information such as a diary, pictures and voice recordings in the server storage device through a web service that authenticates the users. In addition to this, they can disclose this information to different users who have been authenticated by the same web service and who are explicitly specified as a specific disclosure recipient via through the website. This is also a communication between a disclosing person and a disclosure recipient. A user name, which is contact information, is allotted to uniquely identify each communication partner for every SNS service. Various information is disclosed or hidden on the basis of this name. Similar to web mail, many users select multiple SNS services as necessary and exchange a variety of information with any particular partner

In these various communication services, the contact information of the communication partner is stored beforehand in the terminal storage device for each communication service. This contact information is retrieved or obtained by the information terminal by searching from the servers provided by the service provider. In general, each service provider independently provides such communication terminal storage or retaining and retrieving functions of contact information from servers.

Communication terminals such as mobile phones and PC's are used in the aforementioned communication services. Each communication service independently gives each user contact information to uniquely specify a communication partner through that service. In such a situation, as described above, when terminal users communicate with each other by selecting from multiple communication services as necessary, they need to possess their own contact information which may differ for each service in that terminal. For example, let us assume User A of a given PC uses four communication services in all including one e-mail, two IP phones and one text chatting service. The contact information of each communication service is independent and each contact information is given directly by the communication service provider or because, contact information in each communication service is already being used by another user, and therefore may not be obtained, this User A rarely uses the same contact information for these four communication services. For example, using an IP-phone address as it is for an e-mail address may be permitted due to the difference in data format. Therefore, the same person, User A, may have different contact information for each service. The same is also true of another person who is a communication partner of User A, and the same user thus has a lot of contact information throughout the network.

The problems that occur in this situation are explained by referring to FIG. 1. In the example shown in FIG. 1, User A uses an e-mail service V, IP-phone services W and X, and text chatting service Z, a total of four services, by using information terminal 11. Similarly, the communication services V, X, Y and Z are used by the communication terminal 12 of User B, communication services V, W and X are used by the communication terminal of User C, and communication services V, W and Y are used by the communication terminal of user D. This situation enables User A's terminal to provide four contact lists—15 is for e-mail service V, 16 is for IP-phone service W, 17 is for IP-phone service X and 18 for text chatting service Z. Each contact list includes contact information for communication partners in that communication service. For example, the contact information CntX(B) of IP-phone service X of User B and the contact information CntX(C) of IP-phone service X of User C are stored in the contact list 17 of IP-phone service X. The contact information may be stored in the memory device of terminal 11 of User A, or in the server of each service provider and retrieved from the communication terminal 11 of User A through the Internet. Here, since the SNS service Y is not used by the terminal 11 of User A, the contact list for SNS service Y does not exist on terminal 11.

In this condition, User A uses the available communication services W, Y and Z as required to separately communicate with User B, C or D through the communication terminal 11. During this communication, User A faces the following 3 problems.

The first problem is that a person has many different contact lists and the contact information of the same communication partner is dispersed throughout these different contact lists. With reference to FIG. 1, from the viewpoint of the communication terminal of User A, the contact information of user B is dispersed in three contact lists; 15 for E-mail service V, 16 for IP-phone service W and 17 for IP-phone service X. Here, for example, when User A attempts to communicate with User B, he or she first selects the communication service to be used and then selects the contact information of User B from the retrieved contact list. Here, User A wishes to communicate with User B by IP phone. User A simply desires to communicate with User B and is not interested in which IP-phone is to be used. However, for example, User A first retrieves the contact list of IP phone service W from the memory device of a information terminal, and then searches the contact information in User B's IP phone service W. However, since User B does not use the IP phone service W, User B's contact information cannot be found in the contact list 16. Next, User A also retrieves the contact information of another IP phone service X, searches the contact information of User B's IP phone service X, detects CntX (B), and starts communicating with User B based on this detection. If User B uses neither IP phone service W nor IP phone service X, User A may further look for other communicating methods such as e-mail and fixed-line phone in a similar procedure. User A essentially wishes to contact with User B by this series of actions; use of a specific communication service is not the aim. Nevertheless, User A is forced to first select the available communication service and then sequentially select the communicating partner. In this situation, it is necessary for User A to first select the available communication service after understanding which services are used by every partner. But, this becomes difficult as the number of communication services and partners increase. User A has to perform these complicated actions because the contact information of the same partner is dispersed in multiple independent contact lists provided by each service. Furthermore, whether communication with User B, which is the objective of these actions, is possible or not, can be understood only after this series of actions is completed.

The second problem is that management of communication partners is complicated for a user who uses multiple communication services since the same partner may possess different contact information for each communication service. Again, referring to FIG. 1, the contact information on communication services used by User A totals four—CntV(A), CntW(A), CntX(A) and CntZ(A). Due to the aforementioned reason, there are many instances where these contact information are different. This is also the case for Users B, C and D. In this situation, it is assumed User A uses various communication services as necessary and communicates with B, C and D. For example, CntV(B) in the contact list 15 of e-mail service V, CntX(B) in contact list 17 of e-mail service X and CntZ (B) in contact list 18 of e-mail service Z are all different, User A's communication terminal has no method to judge from the contact information supplied by each service provider that all of these are the same User B.

To avoid this problem, a conventional method correlates the names given by communication partners who use the communication service with the respective contact information in the contact list for each communication service. For example, the partner's telephone number and name are correlated and stored in a telephone directory in the contact list of a mobile phone. Therefore, a mobile phone user need not be aware of the telephone number in the contact list, and can call the communication partner merely by selecting the communication partner's name. In this way, even if the same person uses multiple contact information in different communication services, it can be understood by User A's terminal that it is the same person if the partner gives the same name in different communication services. However, the problem in this method is that the names given by the partner are not necessarily the same in all communication services. Especially, in so-called web services such web e-mail, IP phone and SNS service, etc. where much of the user's information correlated with contact information is stored in a communication service provider server and can be searched by all users. For this reason, from the viewpoint of security, many users of these communication services give nicknames protecting anonymity to names correlated with contact information instead of using real names, or they use the services without correlated personal information such as names in the first place. Also, there are many cases where the same person gives different nicknames in each communication service. Further, there are many people who use the same nickname in the same communication service. Therefore, ultimately User A has to manage these corresponding relations such as who owns which contact information in which communication service, and it is still complicated in this respect. Especially as the number of available communication services and partners increase, this problem will become increasingly serious.

The third problem is that the contact list of the communication service, which is not used by the user, cannot be obtained. Again, referring to FIG. 1, the contact list of SNS service Y cannot be used since SNS service Y is not used in User A's terminal 11. For example, User A may wish to know who is using SNS service Y among User A's communication partners in another communication service, even though User A is not using SNS service Y. For example, if User A knows that User D is using SNS service Y, User A may wish to browse User D's SNS page by joining the SNS service Y. However, in conventional techniques, since communication services independently supply each contact list as shown in FIG. 1, User A cannot know that User A's acquaintances B and D are using communication service Y, which User A is not using, through the contact list.

### SUMMARY OF THE INVENTION

According to one aspect of the present invention. an information terminal comprises a microprocessor, said micro processor gathering a plurality of information sets of a user, said user being a communication partner, said information set including an identification tag for specifying said communication partner, communication service information corresponding to a specific communication service among a plurality of communication services and contact information of said communication partner, and a storage device, said storage device storing said plurality of information sets.

According to one aspect of the present invention. a method for selecting a communication service comprises gathering a plurality of information sets of a user, said user being a communication partner, said information set including an identification tag for specifying said communication partner, communication service information corresponding to a specific communication service among a plurality of communication services and contact information of said communication partner, storing said plurality of information sets. extracting a plurality of said communication service information which correspond to said communication partner and displaying a communication service display corresponding to each of said communication service information.

According to one aspect of the present invention. a communication method comprises gathering a plurality of information sets of a user, said user being a communication partner, said information set including an identification tag for specifying said communication partner, communication service information corresponding to a specific communication service among a plurality of communication services and contact information of said communication partner, storing said plurality of information sets. extracting a plurality of said communication service information which correspond to said communication partner, displaying a communication service display corresponding to each of said communication service information and starting to communicate with said specific communication partner by using a communication service corresponding to said communication service display when said communication service display is selected.

According to one aspect of the present invention. a server comprises a microprocessor, said microprocessor gathering a plurality of information sets of a user, said user being a communication partner, said information set including an identification tag for specifying said communication partner, communication service information corresponding to a specific communication service among a plurality of communication services and contact information of said communication partner, and a storage device, said storage device storing said plurality of information sets.

According to one aspect of the present invention. a server comprises a microprocessor, said microprocessor gathering a plurality of information sets of a user, said user being a communication partner, said information set including an identification tag for specifying said communication partner, communication service information corresponding to a specific communication service among a plurality of communication services and contact information of said communication partner, and extracts a plurality of said communication service information which correspond to said communication partner and wherein said information terminal further comprises a display, said display displaying a communication service display corresponding to each of said communication service information and a storage device, said storage device storing said plurality of information sets.

### BRIEF DESCRIPTION OF THE DRAWINGS

FIG. 1 shows an explanatory diagram of the status when multiple communication services are used by multiple Information terminals.

FIG. 2 shows an explanatory diagram of the status when an identification tag for uniquely identifying each communication terminal is send by a common service. [0021] FIGS. 3(A) and (B) show a flow chart describing each step of the present invention.

FIG. 4 shows an explanatory diagram of the communication terminal components in the present invention.

FIG. 5 shows an explanatory diagram of the status when a part of contact information such as used name and additional information etc. is sent to communication partners to a certain extent.

### DETAILED DESCRIPTION OF THE INVENTION

Embodiments of the present invention will be described with reference to the accompanying drawings. The scope of the present invention is defined clearly by that of the accompanying claims. This description should not be interpreted in a limited sense; its aim is to simply exemplify the general principle of the invention.

Definition of the Terminologies

“Contact information” means information that uniquely specifies communication partners in a specific communication service and is required for starting communication with those partners. For example, contact information given to users by the mobile-service provider is the mobile number. Contact information given to users by the e-mail service provider is the e-mail address. Contact information given to users by the SNS service provider is the SNS name.

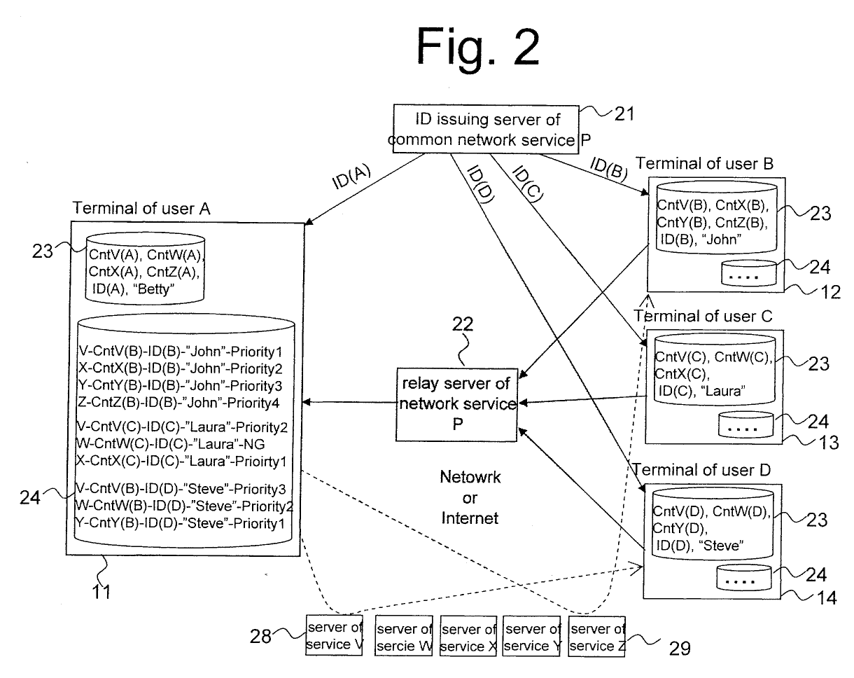

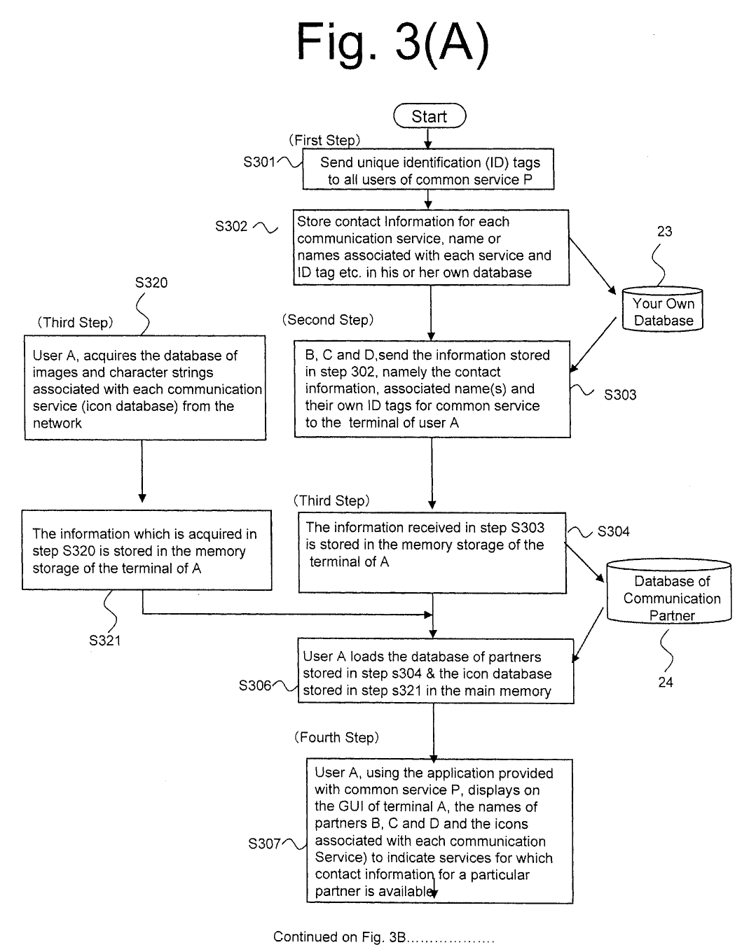

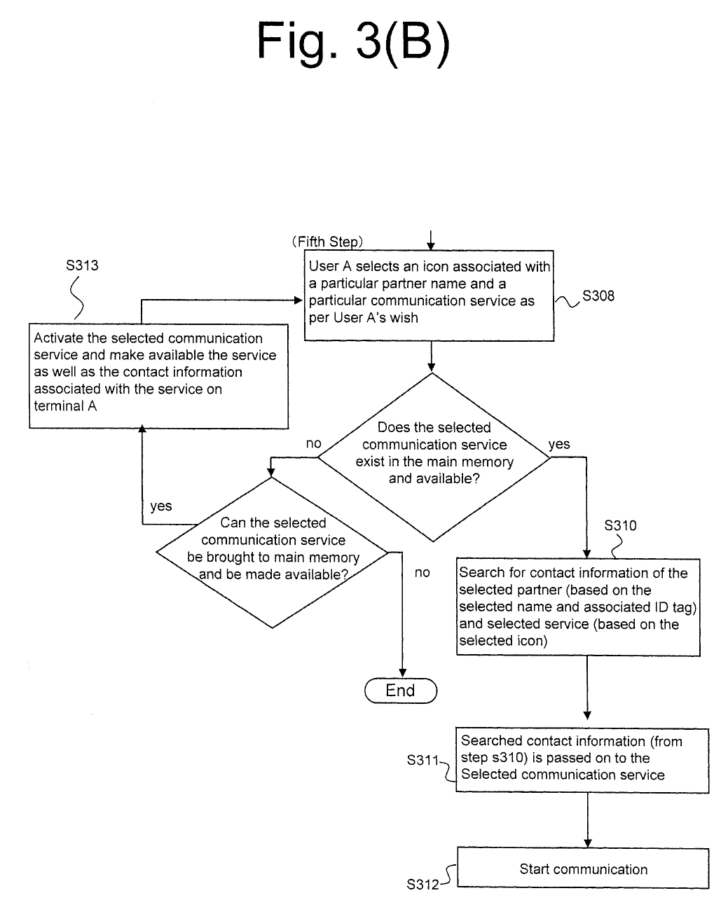

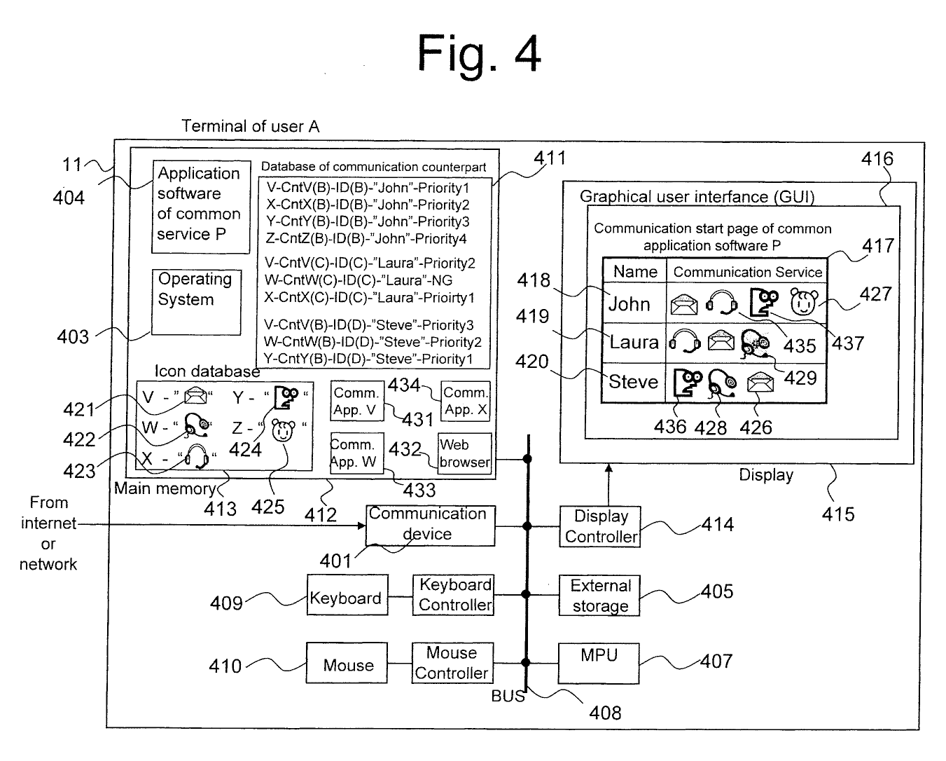

“Contact list” means the aggregate of contact information for communication partners that are stored in the storage devices of communication terminals, or in the servers of the communication service provider and can be retrieved onto the storage devices of communication terminals as necessary. “Communication service information” means the information that is used to uniquely identify a particular communication service in each terminal, for example, V, X, Y and Z are communication service information for the respective communication services in FIG. 2 and FIG. 4. “Communication service display” means a symbol or icon that is used to designate a particular service, usually referred to as icon, as shown as items 421, 422, 423, 424 and 425 in FIG. 4, to indicate communication services V, W, X, Y and Z respectively.

Examples of Communication Terminals

The present invention can be used in various communication terminals connected to a network. The communication terminals used here may be anything ranging from a PC, portable information terminal, fixed-line telephone, mobile phone, game machine, television, video recorder, camera, video camera, to portable music player, etc. Further, even terminals whose main purpose is not communications can be used here. For example, devices such as a PC, game machine, computer and camera can be connected to the network. Hence, all the terminals that can be used to communicate with others in some way or another are called communication terminals. In addition, two terminals or more do not have to be the same type of information terminal. For example, a method of the present invention selects contact information on a mobile phone and a game machine from the PC. The present invention can also be applied when carrying out three-way calls by using three terminals. In addition, the present invention is used for various communication services working in the aforementioned communication terminals. The communication services used here can be in any form ranging from voice communication, video communication, browsing various information on websites, uploading of information to websites, chatting and e-mail to file transmission.

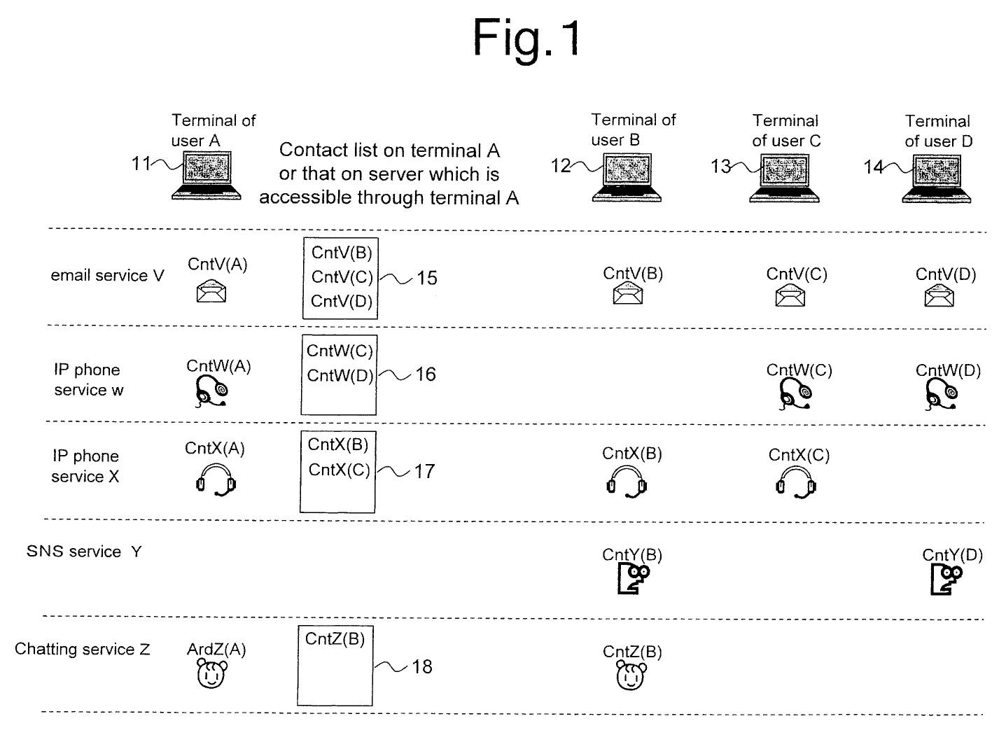

In the example shown in FIG. 1, User A is using four communication services such as e-mail service V, IP-phone service W, IP-phone service X and text chatting service Z, with the help of information terminal 11. Similarly, User B is using communication services of V, X, Y and Z with the help of communication terminal B, User C is using communication services of V, W and X, and User D is using communication services of V, W and Y with the help of their respective communication terminals. The users are using multiple types of communication services according to their needs or the needs of their communication partner. In this situation, referring to FIG. 2, in addition to the above-mentioned communication services V, W, X, Y and Z, one embodiment of the present invention has another common service P independent of these, to exchange contact information in these services. This common service P has an identification-issuing server 21 and an information relay server 22 as its components. Here, all users A, B, C and D are the users of this common service P. The following description is shown in FIG. 3 in the form of a flow chart.

### EMBODIMENT ONE

In the first step of this embodiment one, identification-issuing server 21 of common service P sends identification tags to the communication terminal of each user for uniquely specifying each user of common service P (Step S301). In the example shown in FIG. 2, four identification tags ID (A), ID (B), ID (C) and ID (D) are sent to communication terminals A, B, C and D respectively. Next, in each terminal receiving these identification tags, along with the user's contact information used by the communication service in the terminal, the received tags are stored in the user's information storage device or storage area 23. At the same time, any given name along with these identification tags and contact information is decided so that users are easily recognized by the partner's communication terminal. This can be stored in the user's information storage device or storage area 23. (Step S302). For example, in User B's terminal, in addition to ID (B) received from the identification-issuing server 21, Cnt V (B), Cnt X (B), Cnt Y (B) and Cnt Z (B), which are User B's contact information in User B's various communication services, the name, Name (B), declared to a communication partner are stored in the information storage device or storage area 23 in User B's terminal. The name could be either a name common to all communication services used or a different name for each communication service. If different names are given for each communication service, the contact information for each communication service and the given name are correlated and stored. Similarly, in the communication terminals of Users A, C and D, individual contact information, identification tags and names declared to communication partners are stored in the user's own information storage device or storage area 23.

Next, in the second step, each user transmits communication service name, their contact information and their name declared to partners, stored in the aforementioned first step to each information terminal by associating with identification tags for common service P. (Step S303) The communication service name, their contact information and their name declared to partners, which are correlated with these identification tags, can be received and transmitted by using information relay servers of common service P, or by using a communication service commonly joined by these senders and partners. Further, the above can be carried out through servers or the network with peer-to-peer connection. For example, in the example shown in FIG. 2, Users B, C, and D transmit the communication service information used by respective communication terminals, their contact information in that communication service and names declared to partners to User A's terminal; by correlating with identification tags for common service P through information relay servers of common service P. For example, User B's terminal transmits communication service name V, User B's contact information Cnt V (B) in that communication service and Name (B) given by User B for Partner A, to User A's terminal by correlating with identification ID (B) for common service P of User B.

Moreover, in this step, it is not necessary to transmit all communication service information, their contact information and their names declared to partners, correlated with their identification tags to all partners. However, by not transmitting these pieces of information to a specific partner, a communication request can also be avoided from that partner in the specified communication service. For example, in FIG. 2, if User B intentionally does not transmit the communication service name V, contact information Cnt V (B), and given name “John,” related to his or her identification ID (B), to User A's terminal 11, then, these are not stored in User A's terminal. This avoids a communication request from User A's terminal 11 to User B's terminal through e-mail service V in the following step.

Moreover, the name transmitted and declared to partners, correlated with the identification tag, can be different for each communication service. In the example in FIG. 2, User B declares a name to User A by correlating to identification ID (B), while transmitting from User B's terminal 12 to User A's terminal 11. User B uses the same name “John” for all communication services V, X, Y and Z. However, it is possible to correlate and transmit different names for each communication service.

Moreover, the name, which is transmitted to partners correlated with the identification tag and declared to them, may be different for each partner. For example, in FIG. 2, User B declares name “John” to User A while transmitting from User B's terminal 12 to User A's terminal 11, correlated with the identification ID (B). Similarly, User B may declare, for instance, some nickname other than “John” to User C while correlating to identification ID (B) and transmitting to User C's terminal.

In addition, different users may give the same name. For example, in FIG. 2, User B and User D may use the same name “Smith” for User A. In the present invention, since names given by all users are used in association with unique identification tags among users, it is not necessary for every user to specify the user uniquely by the name given by each user.

In FIGS. 2 and 4, the additional information starting with “Priority” and “NG” is used for explaining embodiment two but not used to explain this embodiment.

FIG. 4 shows the components of User A's terminal 11, shown in FIG. 2, in a block diagram. Referring to FIG. 4, in the second step as mentioned above, the communication service name, sender's contact information in the service and names given by senders are transmitted from users B, C and D, along with the correlated identification tags for common service P. In the third step, communication mechanism 401 receives the information. Microprocessor 407 stores this information through a bus 408 into storage 405 as per the instructions specified in application software 404 for common service P running on the operating system 403. (Step S304) The program 404 of the common service may be located either in the main memory 412 of User A's terminal 11, or in the storage device of other communication terminals through the network. User A loads the database 411 of partners, including communication service information, each contact information and each used name received from Users B, C and D and tagged with identification tags for each common service P, to the main memory device 412 by operating keyboard 409 and mouse 410 in this service. (Step S306) Similarly, they also load the database 413 of images and character strings correlated with each communication service (hereinafter called “icon database”) to the main memory device 412. User A may create this icon database in advance and store it in the storage 405. Otherwise, if necessary, it may be obtained through communication mechanism 401 from the network (Step S320), stored in the storage (Step S321) and loaded in the main memory (Step S306). Otherwise, in the second step, User A's partner sends the communication service name, contact information and used name along with the icon correlated with communication service and correlated in the identification tags. These are received by User A's terminal. It may be created from the partner database including icon information loaded in the third step. Moreover, this icon may be made up of image data or of some character information.

Next, in the fourth step, User A operates the keyboard 409 or mouse 410 to instruct the application software 404 for common service P to display the communication start screen. Microprocessor 407 displays the communication start screen 417 onto the graphical user interface 416 (hereinafter referred as “GUI”) shown on the display device 415 through display controller 414. This is based on the partner's database 411 and icon database 413 loaded in the main memory device of User A's terminal in the third step. The communication start screen 417 does not indicate contact information and identification tags but the category of partners' used names and communication services correlated with partner identification tags. In the example of the communication start screen shown in FIG. 4 (Step S307), four icons such as icon 421 correlated with e-mail service V, icon 423 correlated with IP phone call service X, icon 424 correlated with SNS service Y and icon 425 correlated with text chatting Z in an icon database are displayed on line 418 of User B who uses “John” as their name. Similarly, icons correlated with V, W and X are arranged on the line of User C who uses “Laura” as their name, and those correlated with V, W and Y on the line of user D who uses “Steve” as their name, respectively. Rows and columns are interchangeable on this communication start screen 417. Information displayed on the communication start screen is not limited to icons. Any information, other than contact information, correlated with partner identification tags may be displayed on the communication start screen.

Then, in the fifth step, User A operates the keyboard 309 and mouse 310 to select the icons correlated with a communication service to be used for partners to be communicated with, displayed on the communication start screen 417. (Step S308) If the application software for executing this communication service exists on main memory 412 and this service is available, application software 404 for common service P searches contact information located in the partner database 411 on main memory device 412, by considering the communication service name correlated with a selected icon and identification tags correlated with a partner name as a search key (Step S310). The searched contact information is passed over to the application software for the selected communication service as a result (Step S311). The application software for this service starts communications with selected partners through communication mechanism 401 based on the received contact information (Step S312). In the example shown in FIG. 4, for example when User A sends an e-mail to User D named “Steve” displayed on communication start screen 417, User A operates mouse 410 to select icon 426 located in communication start screen 417 that shows the e-mail service V of User D named “Steve.” Then, the application software P searches the contact information correlated with the identification ID (D) and e-mail service of User D, by setting these two as search keys, in the controlled partner database 411. The contact information CntV (D) of User D's e-mail service V obtained from the search result is sent to e-mail service application software 431. This application software starts communications with User D's terminal through e-mail V server 28 through communication mechanism 401 by using this Cnt V (D). For instance, when User A selects icon 427, contact information in text chat service Z of User B is sent to web browser 432. User A can browse the page on text chat service Z of User B by the name of “John” through chat service Z server 29.

In conclusion, the following eight advantages of this invention explained in embodiment one, as compared to the method of starting communications by using separate contact lists for each conventional communicating service, can be cited.

First advantage: Communication terminal users can first select the person to be communicated with and then select a communication service. According to conventional methods, it was necessary to select the partner after first selecting the communication service when wishing to start communication with a specific partner. This is because the same person's contact information is scattered in contact lists for each communication service. According to this invention, communication can be started by a communication service desired by a terminal user with partners intended by the user; in either way—by first selecting a partner and then selecting a communication service available for communication with the partner, or as carried out before, by first selecting a communication service and then selecting a partner who can be communicated with in that service. In the light of intrinsic communication purposes, it is more important to select the intended partners rather than communication services. This first advantage of the present invention will significantly increase the convenience of communication terminals.

Second advantage: Since the communication services available for each partner are displayed in a list, the user of an information terminal will not have to manage communication service availability for each partner independently. For example, in the example given in FIG. 1, according to conventional methods, User A had to remember that User C used three communication services, namely e-mail service V, IP phone service W and IP phone service X. When communicating with User C, communications had to be started by selecting User C from the contact list of available communication services after displaying the contact list on the display device of the communication terminal. According to this invention, User C who is named “Laura” is displayed in a list on the communication start screen 417 by using icons for communication services V, W and X in operation. User A, who is using communication terminal 11, does not have to memorize which communication services are available to communicate with User C.

Third advantage: Communications can be started with multiple partners or through multiple communication services by a simple operation to select multiple icons on one communication start screen. In the example shown in FIG. 1, according to the conventional method, when User A wished to communicate with User B by simultaneously using two communication services, namely, IP phone service X and chatting service Z, User A firstly had to put contact list 17 of IP phone service X on the display and then start communicating with User B by using this service after selecting Cnt X (B) in it. Then, communications with the same User B in service Z should be started by selecting different contact information Cnt Z (B) that showed the same User B after displaying the contact list Z of text chatting service Z on the display. In other words, according to conventional methods, communication was easily started with partners by selecting multiple partners simultaneously from the contact list of one communication service. However, a user of information terminals had to execute such complex steps to start communication with one or more partners by multiple communication services. According to this invention, as seen in FIG. 4, User A can start communicating with User B by merely selecting both icon 435 for IP phone service X in “John” line 418 and icon 427 for text chatting service located on the communication start screen 417, GUI 416, display 415, to use these two services simultaneously. As a concrete measure to actualize this, in the present invention, when these two icons are selected, the application software 404 for common service P searches contact information of IP phone service X and text chatting service Z for User B named “John” in the partner's database 411. It sends respective contact information to application software 434 for service X and web browser 432 in charge of service Z respectively. On the basis of the contact information received, each of the application software starts communicating with User B. Thus, according to this invention, communications using one or more communication services can be started by using a simple operation to select multiple icons on the communication start screen.

Fourth advantage: Even if the same partner uses differing contact information in each communication service, it can be displayed on the communication start screen as a list after communication terminals recognize this different information as the same person. In the example given in FIG. 1, in conventional methods there was no means for User A's terminal to recognize that two pieces of contact information belonged to the same person, when Cnt W (C) existing in the contact list 16 of IP phone service W and Cnt X (C) existing in the contact list 17 of IP phone service X displayed on User A's terminal 11 were different. Refer to FIG. 2. The present invention correlates identification ID (C), issued from an identification issuance server of common service P to User C's terminal 14, with the name “Laura” given by User C, and CntV (C), CntW (C) and CntX (C) (contact information for services V, W and X, respectively) saved in User C's terminal 14. They are also stored in the memory device on User A's terminal 11. The identification ID (C) of common service P is information to uniquely specify each user independently from the contact information used in communication services V, W, X, Y and Z. Then, as in FIG. 4, identification ID (C), in each of CntV (C), CntW (C) and CntX (C), and User C named as “Laura” are correlated with and stored in the partner's data base 411. Therefore, application software 404 of common services P read onto main memory device 412 of User A's terminal 11 can identify that different contact information of these three belongs to User C who is the same person named as “Laura”. As a result, the terminal of User A can display icons of communication service V, W and X in the line 419 of User C named as “Laura” in the GUI 416 of display device 415 as a list of communication services available for communicating with User C.

Fifth advantage: Multiple partners, who are different people using the same contact information on different communication services, can be recognized as not being the same person but different partners by the communication terminal and displayed accordingly on the communication start screen. As in the example shown in FIG. 1, the contact lists 15, 16, 17 and 18 in each communication service available in User A's terminal are independent of each other. As it is necessary to specify the partner in each communication service, the uniqueness of contact information is secured for each partner in the contact list of each communication service. However, there is no guarantee that contact information used by different communication services does not overlap. For example, the contact information Cnt W (C) of User C in IP phone service W in User A's terminal and the contact information Cnt X (B) of User B in IP phone service X may be the same. Therefore, conventional methods found no means to determine at User A's terminal whether the contact information on Cnt W (C) and Cnt X (B) came from different partners or the same partner. However, according to this invention, as in FIG. 4, both User B and User C are users of common service P. In the partner database 411, ID (C) is correlated and stored with Cnt W (C), and ID (B) with Cnt X (B) respectively. Therefore, even if Cnt W (C)=Cnt X (B), the uniqueness of an identification tag concerning users of common service P is secured. Namely, since ID (C)≠ID (B), the application software 404 for common service P of User A's terminal 11 can recognize that these two pieces of contact information belong to different partners. Therefore, even if Cnt W (C)=Cnt X (B), the application software 304 for common service P can display icon 429 correlated with IP phone service W in the line of User C named as “Laura” based on Cnt W (C) and icon 435 correlated with IP phone service X in the line of User B named as “John” based on Cnt X (B) respectively on the communication start screen 417. And, the same contact information can be displayed as the contact information of different partners.

Sixth advantage: It can be easily known if a partner uses the communication service which is not used by the user of an information terminal. In the example shown in FIG. 1, by the conventional method, User A does not use SNS service Y and cannot use the contact list of service Y. Therefore, there is no means via SNS service Y for User A to know the fact that User B and User D are using SNS service Y and the contact information of User B and User D in SNS service Y. Thus, in the conventional method, in order to acquire the contact information of User B for SNS service Y, User A had to first request User B explicitly for the contact information through a communication service other than SNS service Y and used commonly by user A and user B. Then, User B's information terminal needed to send this information to User A's terminal. However, User A cannot use the contact list of SNS service in the first place and does not know the fact that User B uses SNS service Y. Therefore, User A does not usually request User B for the contact information of SNS service Y. However, as seen in FIG. 4, in the method of the present invention, although SNS service Y is not used, in information terminal of User A, the contact information on User B's and User D's terminals concerning SNS service Y sent by Users B and D has been stored in the partner database 411. Hence, the communication start screen 417 displays icon 437, correlated with SNS service Y, in the line 418 of User B called “John” and icon 436, correlated with SNS service Y, in the line 420 indicating User D named “Steve.” Since SNS service Y is not used in User A's terminal 11, User A cannot start communicating with User B or D, by using SNS service Y, even if User A selects these icons with mouse 410. However, since the web browser 432 of User A's terminal 11 works through communication mechanism 401 and connects to the provider servers of SNS service Y, and acquires programs or contact information, if User A selects these icons, they can become a new user of SNS service Y (Step 313). Thus, User A will be able to communicate with Users B and D by using SNS service Y. User A can search others who use a communication service not used by User A without performing complicated operations. From the point of view of the communication service provider, this strongly motivates a person who does not use the provider's communication service to start using it. It also contributes commercially to a significant increase in the number of users of these communication services.

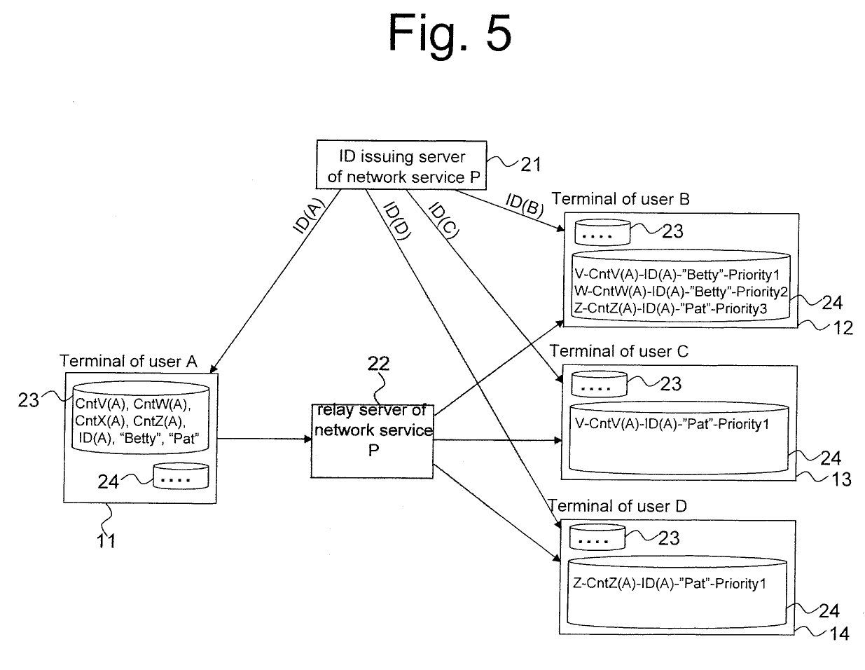

Seventh advantage: a communication service to be used and the receiving of communication requests from the communication partners can be selected optionally, by selectively sending the contact information of a communication service and correlated sender's identification in the sender's terminal to specific communications partners. In the example given in FIG. 5, four communication services such as e-mail service V, IP phone service W, IP phone service X and text chatting service Z are available in User A's terminal 11. Assuming that User A agrees to receive a communication request from User B by communication service of V, W or Z, and enters this intention into User A's terminal, then, User A's terminal correlates the contact information of the three communication services V, W and Z with identification ID (A) and sends those to User B's terminal. User B's terminal stores these into partner's information memory or memory area 24. Here, User A does not wish to receive a communication request through IP phone service X from User B, and does not send it to User B's terminal. By a similar method, User A receives communications only through e-mail service V from User C and only through text chatting from User D. This selectively specifies the communication services to be used by communication partners.

Eighth advantage: The name used for a partner can be flexibly changed. Among different communication services, different names for different partners could also be used according to the conventional method. In FIG. 1, for instance, User A could use different names—for the name declared to Users C and D in IP phone service W and correlated User A's contact information Cnt W (A), and for the name declared to Users B and C in IP phone service X and correlated User A's contact information Cnt X (A). However, in the conventional method, for example, User A had only one contact information Cnt W (A) to correlate a name in IP phone service W. User A could not declare different names to Users C and D who used the same IP phone service W. However, the method in the present invention makes it possible to declare different names more flexibly than the conventional method. In the example shown in FIG. 5, User A gives the same nickname “Pat” to Users B and D of partners in text chatting service Z. Different names can be used for different partners in one communication service such as the name “Betty” for User B and the nickname “Pat” for User C of partners in e-mail service V. The eighth advantage especially provides greater flexibility to users who use various communication services with different characteristics. For example, many SNS services require anonymous communications on the network without disclosing real names to communicating partners. It is necessary to use names different from those in IP phone services. Further, for example, one of the two partners of a user of IP phone service is related in business and the other one is related in private affairs. In this case, they may wish to express their real name to the business partner or their nickname to the private partner. By the method in the present invention, names declared to partners can be flexibly changed by using identification tags that do not depend on the communication service.

The present invention enables a user using multiple independent communication services of various types on a single communication terminal to conveniently manage contact information for partners differing for each communication service and to establish communications with partners easily by a desirable communication means as necessary.

### EMBODIMENT TWO

Another embodiment is given below. In the above-mentioned embodiment one, in the terminal of communication service users, contact information of communication services and names used for partners are correlated with an identification tag to uniquely identify a partner on common service P and sent to the communication partners. In embodiment two, in addition to contact information and names used for partners, additional information correlated with an identification tag for common service P is sent to the partners, and it is used by partner terminals. The method of adding the effects of the present invention is described here. Parts that overlap with the description of the above-mentioned embodiment one are omitted in that of embodiment two. FIGS. 2, 3 and 4 are used for diagrams required for its description.

In the first step of embodiment two, the same as in the above-mentioned embodiment one, identification issuing server 21 of common service P sends an identification tag to the communication terminals of each user (Step S301). In the example given in FIG. 2, four identifications ID (A), ID (B), ID (C) and ID (D) are sent to terminals A, B, C and D respectively. Next, in the terminal in receipt of these identifications, identifications received, receiver's contact information used for the terminal available in the communication services, and names that each user declares to communications partners are then stored into the receiver's information memory or memory area (Step S302).

Next, in the second step, communication service information available for a communications terminal, the contact information, names that a user declares in each communication service, and additional information for each contact information are correlated with identification tags for common service P stored in the first step, and sent to the information terminals of communications partners (Step S303). The additional information in this case may be any kind of information. In addition, any number of additional information is permitted. In this case, for instance, individual additional information may include a flag to show that it is an correlated communication service and whether the terminal user may demand it for communication launching. It can be a flag representing a request priority sequence in the case where the terminal users are demanded for communications to start, or a key or pass code used for authentication or encryption. This additional information may include anything such as a user's nickname in the communication terminal, another name, or some other contact information, etc. As mentioned above, additional information may be added to every contact information of communication services separately, or devised to add one flag to every communications terminal. Additional information in this case as well may include any kind of information. For instance, in this case, it may be a flag representing whether a terminal user can communicate at present, or anything like a key and pass code used for authentication or encryption in each information terminal. In the example given in FIG. 2, User B's terminal correlates the communication service name V, contact information Cnt V (B) of User B in the communication service and User B's Name (B) declared to communication partner User A, and additional information “Priority1” with identification ID (B) in User B's common service P, and sends it to User A's terminal. Other contact information and other users are similarly applicable.

Next, FIG. 4 is referred to. Communication service information, the sender's contact information in the communication service, each information for the name by which the sender is identified and additional information, correlated with identification tags of common service P sent from Users B, C and D in the above-mentioned second step, are received by communication mechanism 401 in the third step. They are then stored in storage 405 by the process similar to that of the above-mentioned embodiment one. (Step S304). Moreover, they are loaded to the main memory 412 as partner database 411 (Step S306). Here, in the example shown in FIGS. 2 and 4, the above-mentioned additional information is sent from Users B, C and D and is stored in User A's terminal. This information indicates the priority level of the communication services by which each user of the information terminal which transmitted these items of information would like to communicate with User A. For example, partner database 411 in FIG. 4 is referred to. User B requests the communications in the priority order of email service V, IP phone service X, SNS service Y and finally text chatting service Z, when User A requests communication with User B. User B expresses their intention by the flags of “Priority 1”, “Priority 2”, “Priority 3” and “Priority 4” correlated with the contact information of User B. Similarly, partner database 411 in FIG. 4 is referred to. User C expresses by the flag “NG” that they does not wish to communicate with User A through IP phone service W. For example, when User B specifies the priority for each communication service by additional information, the same priority can be set to all of their partners, or additional information indicating different priorities to every partner of User B can also be set. For example, User B wishes to communicate mainly by e-mail with their acquaintance User A but communicate mainly by SNS service with another acquaintance User E. In this case, it can be implemented by correlating and sending the flag to represent the different priorities for each communication service.

Next, in the fourth step, the communication start screen 417 appears as shown in FIG. 4 by a method similar to the fourth step in the above-mentioned embodiment one. In the example shown in FIG. 4, icons correlated with each communication service are displayed on the communication start screen 417 in the priority order correlated as additional information for each contact information of individual communication service sent from Users B, C and D in the second step of embodiment two (Step S307). For example, the icons are arranged in the line that indicates User B named “John” on the communication start screen 417. These icons are correlated with e-mail service V, IP phone service W, SNS service Y and eventually text chatting service Z, lined up from the left. This shows the communication service priority to be used by User A to communicate with User B. Partner database 411 as shown in FIG. 4 is referred to. User C named “Laura” is marked as “x” to this corresponding icon 429 on the communication start screen 417 to clarify the intention of not communicating with User A through IP phone service W, by using the additional information “NG” correlated with the contact information on IP telephone service W.

Next, in the fifth step, User A operates keyboard 409 and mouse 410 to select an icon correlated with the communication service of partners to be communicated with, displayed on the communication start screen 417 (Step S308). Then, communications will be started by the same method as in the fifth step as described in embodiment one (Step S312).

The above description deals with the comparison of the present invention in embodiment two with conventional methods where communications are launched with independent contact lists for each communication service. The following advantages might be added to the above-mentioned eight advantages.

As far as the advantages involved in embodiment two, a list of communication states for each partner and each service, partner intentions, or any other information related to the communication service are displayed on the display device. This information is capable of controlling communication with partners. For example, FIG. 1 is referred to. Both Users A and B commonly use three communication services such as e-mail service V, IP phone service X and text chatting service Z. Hence, when User A wished to communicate with User B, User A can start communicating with User B by using any of these communication services. However, on the other hand, when a request for communication with User B is made by User A while they are away from their terminal, User B may not wish to communicate by IP phone but by e-mail. In such circumstances by the conventional method, User A first displayed the contact list of IP phone service X on the display device. Then, User A attempted to communicate by selecting the contact information Cnt X (B) for User B from that list. At this point User A realized communication was not possible because User B did not use the service X at that time. Then, User A displayed the contact list of text chatting service Z and attempted to communicate by selecting the contact information Cnt Z (B) from that list. It was then that User A realized that User B did not use the service Z. Further, User A displayed the contact list of e-mail service V, selected Cnt V (B) from it, and then sent User B an e-mail. Many such steps had to be executed in the conventional method. FIG. 4 for the partner database 411 in the present invention method is referred to. In the present invention, however, along with contact information sent to User A's terminal in correlation with the identification ID (B) for common service P from User B, priorities 1 to 4 are correlated as additional contact information to represent the desired priority order, when User A attempts to communicate with User B. Thus, icons correlated with each communication service are displayed on the communication start screen 417. They are arranged in the desired order when User B named “John” attempts to communicate with User A; in other words, in the sequence of communication services V, X, Y and finally Z. For this reason, User A can notify the communication service to be used which is desired by User B prior to an actual communicating attempt. Hence, it has the advantage of not requiring complicated operations unlike in the traditional method. These priorities may be displayed on display 415 in every means of character information and graph as well as icon indication order.

Here, the additional information correlated with contact information and identification tags of each partner could be anything. Refer to FIG. 1 for another case when User A starts to communicate with User C by IP phone. There was no device to detect whether either or both of IP phone service W and IP phone service X were available at the moment of starting the operation. In the present invention, the information terminal of user A can display which communication channels are available at the present moment on communication start screen 417 in FIG. 4, if the information terminal of a communication partner correlates the additional information, which indicates the availability of each communication channel at the present moment, with a partners' identification and respective contact information, sends them to user A's information terminal, and if the information terminal of user A stores this information. In other words, the status information for a particular partner's information terminal and a particular communication service can be conveyed to the communication terminals of other partners. Status information is one of the examples of the additional information that can be communicated between the information terminals of different users. With the exchange of status information, a service is provided to show in real time whether partners can communicate by a certain communication service at the present moment, besides a contact list. This service is generally called a presence service. It was also implemented in some communication services such as IP phoning in the conventional method. However, there was no method where communication terminal users completely managed the presence information in multiple communication services. In the present invention, the presence information of multiple communication services is listed and displayed on the communication start screen 417 shown in FIG. 4, which improves user-friendliness for users of communication terminals.

The present invention enables a user using multiple independent communication services of various types on a single communication terminal to conveniently manage contact information for partners differing for each communication service and to establish communications with partners easily by a desirable communication means as necessary.

What is claimed is:

1. An information terminal comprising:
a microprocessor, said micro processor gathering a plurality of information sets of a user, said user being a communication partner, said information set including an identification tag for specifying said communication partner, communication service information corresponding to a specific communication service among a plurality of communication services and contact information of said communication partner, and;
a storage device, said storage device storing said plurality of information sets.

2. The information terminal according to claim 1, wherein said microprocessor extracts a plurality of said communication service information which correspond to said communication partner and wherein said information terminal further comprises a display, said display displaying a communication service display corresponding to each of said communication service information.

3. The information terminal according to claim 1, wherein said identification tag is unique so as to specify said communication partner among all of said users.

4. The information terminal according to claim 2, wherein said information terminal starts to communicate with said specific communication partner by using a communication service corresponding to said communication service display when said communication service display is selected.

5. The information terminal according to claim 2, wherein said information terminal obtains said plurality of information sets from a server.

6. The information terminal according to claim 1, wherein said information set further includes status information of said communication partner, said display displaying a status of said communication partner based on said status information within said specific communication service.

7. The information terminal according to claim 2, wherein said information set further includes status information and wherein said display displays a status based on said status information of said communication partner within said specific communication service and wherein said display displays said communication service display according to said status information.

8. A method for selecting a communication service comprising:
gathering a plurality of information sets of a user, said user being a communication partner, said information set including an identification tag for specifying said communication partner, communication service information corresponding to a specific communication service among a plurality of communication services and contact information of said communication partner,
storing said plurality of information sets.
extracting a plurality of said communication service information which correspond to said communication partner: and
displaying a communication service display corresponding to each of said communication service information.

9. The method for selecting a communication service according to claim 8, said information set further including status information, and said method further comprising displaying a status based on said status information of said communication partner within said specific communication service.

10. The method for selecting a communication service according to claim 8, said information set further including status information and said method further comprising displaying a status based on said status information of said communication partner within said specific communication service and displaying said communication service display according to said status information.

11. A communication method comprising:
gathering a plurality of information sets of a user, said user being a communication partner, said information set including an identification tag for specifying said communication partner, communication service information corresponding to a specific communication service among a plurality of communication services and contact information of said communication partner,
storing said plurality of information sets.
extracting a plurality of said communication service information which correspond to said communication partner:
displaying a communication service display corresponding to each of said communication service information; and
starting to communicate with said specific communication partner by using a communication service corresponding to said communication service display when said communication service display is selected,

12. The communication method according to claim 11, said information set further including status information, and said method further comprising displaying a status based on said status information of said communication partner within said specific communication service.

13. The communication method according to claim 11, said information set further including status information and said method further comprising displaying a status based on said status information of said communication partner within said specific communication service and displaying said communication service display according to said status information.

14. A server comprising;
a microprocessor, said microprocessor gathering a plurality of information sets of a user, said user being a communication partner, said information set including an identification tag for specifying said communication partner, communication service information corresponding to a specific communication service among a plurality of communication services and contact information of said communication partner; and
a storage device, said storage device storing said plurality of information sets.

15. A server comprising;
a microprocessor, said microprocessor gathering a plurality of information sets of a user, said user being a communication partner, said information set including an identification tag for specifying said communication partner, communication service information corresponding to a specific communication service among a plurality of communication services and contact information of said communication partner, and extracts a plurality of said communication service information which correspond to said communication partner and wherein said information terminal further comprises a display, said display displaying a communication service display corresponding to each of said communication service information; and
a storage device, said storage device storing said plurality of information sets.

16. The server according to claim 14, wherein said identification tag is unique so as to specify said communication partner among all of said users.

17. The server according to claim 15, wherein said information terminal starts to communicate with said specific communication partner by using a communication service corresponding to said communication service display when said communication service display is selected,

18. The server according to claim 15, wherein said information terminal obtains said plurality of information sets from a server.

19. The server according to claim 14, wherein said information set further includes status information, said display displaying a status based on said status information of said communication partner within said specific communication service.

20. The server according to claim 15, wherein said information set further includes status information and wherein said display displays a status based on said status information of said communication partner within said specific communication service and wherein said display displays said communication service display according to said status information.
